(19) United States
(12) Patent Application Publication
(10) Pub. No.: US 2024/0080823 A1
(43) Pub. Date: Mar. 7, 2024

(54) METHOD AND NETWORK NODE FOR HANDLING PUCCH RESOURCES IN A FREQUENCY SPECTRUM OF THE COMMUNICATIONS SYSTEM

(71) Applicant: Telefonaktiebolaget LM Ericsson (publ), Stockholm (SE)

(72) Inventors: Liheng LIU, Helsingborg (SE); Björn BOSTRÖM, Spånga (SE); Björn NORDSTRÖM, Hässelby (SE)

(21) Appl. No.: 18/270,044

(22) PCT Filed: Jan. 25, 2021
(86) PCT No.: PCT/SE2021/050044

§ 371 Date: Jun. 28, 2023

(51) Int. Cl. H04W 72/0453; H04W 72/21; H04W 72/52; H04W 72/566

(52) U.S. Cl. CPC H04W 72/0453; H04W 72/21; H04W 72/52; H04W 72/566

(57) ABSTRACT

The present disclosure relates to a method performed by a network node in a communications system for handling PUCCH resources in a frequency spectrum. The network node categorizes the PUCCH resources into a plurality of congestion level groups. The network node assigns the categorized PUCCH resources to different parts of the frequency spectrum. The first congestion level group is assigned to a first part of the frequency spectrum and the PUCCH resources categorized in the second congestion level group are assigned to a second part of the spectrum. The network node determines that the PUCCH resources categorized in the first congestion level group and assigned to the first part of the frequency spectrum should be used by the UE prior to using the PUCCH resources categorized in the second congestion level group and assigned to the second part of the frequency spectrum.

### TECHNICAL FIELD

The present disclosure relates generally to a network node in a communications system and a method performed by the network node. More particularly, the present disclosure relates to handling Physical Uplink Control Channel (PUCCH) resources in a frequency spectrum of the communications system.

### BACKGROUND

PUCCH is a physical control channel which carries a set of information called Uplink Control Information (UCI), and the PUCCH is classified into various PUCCH formats, depending on what information that the UCI carries. The UCI may comprise a Channel Quality Indicator (CQI), a Hybrid Automatic Repeat Request (HARQ) Acknowledgement (ACK) or HARQ Negative Acknowledgement (NACK) and uplink scheduling requests. Some examples of PUCCH formats are: format 1 where the UCI carries a Scheduling Request (SR), format 1 a where the UCI carries a 1-bit HARQ ACK/NACK with/without SR, format 2 where the UCI caries a Channel Quality Indicator (CQI) etc.

The concept of PUCCH resource set is introduced in Third Generation Partnership Project (3GPP) New Radio (NR). A PUCCH resource set comprises a number of PUCCH resources each corresponding to a PUCCH format, a first symbol, a duration, a Physical Resource Blocks (PRB) offset and a cyclic shift index set for a PUCCH transmission. A PUCCH resource may be referred to as a resource herein for the sake of simplicity.

A User Equipment (UE) is configured over a Radio Resource Control (RRC) with two or more PUCCH resource sets which comprises all the HARQ-ACK resources the network can assign to the UE when scheduling Physical Downlink Shared Channel (PDSCH) data. Selection of which resource set to use for HARQ-ACK is done by the UE based on the number of feedback bits it will send, and the selection of which resource in the resource set to use is signaled from network to UE in downlink control information.

Chapter 9.2.1 of 3GPP TS 38.213 V16.4.0 (2020-12) states that “The maximum number of PUCCH resources in the first PUCCH resource set is 32 and the maximum number of PUCCH resources in the other PUCCH resource sets is 8”. Chapter 9.2.3 of 3GPP TS 38.213 V16.4.0 (2020-12) states that “The PUCCH resource indicator field values map to values of a set of PUCCH resource indexes, as defined in Table 9.2.3-2, provided by ResourceList for PUCCH resources from a set of PUCCH resources provided by PUCCH-ResourceSet with a maximum of eight PUCCH resources.” Table 1 below corresponds to table 9.2.3-2 in 3GPP TS 38.213 V16.4.0 (2020-12) and provides an overview of the mapping of PUCCH resource indication field values to a PUCCH resource in a PUCCH resource set with maximum 8 PUCCH resources. The left column represents a PUCCH resource indicator and the right column represents the PUCCH resource.

TABLE 1

| PUCCH | |
|---|---|
| resource indicator | PUCCH resource |
| ‘000’ | 1^{st} PUCCH resource provided by pucch-ResourceId |
| | obtained from the 1^{st} value of resourceList |
| ‘001’ | 2^{nd} PUCCH resource provided by pucch-ResourceId |
| | obtained from the 2^{nd} value of resourceList |
| ‘010’ | 3^{rd} PUCCH resource provided by pucch-ResourceId |
| | obtained from the 3^{rd} value of resourceList |
| ‘011’ | 4^{th} PUCCH resource provided by pucch-ResourceId |
| | obtained from the 4^{th} value of resourceList |
| ‘100’ | 5^{th} PUCCH resource provided by pucch-ResourceId |
| | obtained from the 5^{th} value of resourceList |
| ‘101’ | 6^{th} PUCCH resource provided by pucch-ResourceId |
| | obtained from the 6^{th} value of resourceList |
| ‘110’ | 7^{th} PUCCH resource provided by pucch-ResourceId |
| | obtained from the 7^{th} value of resourceList |
| ‘111’ | 8^{th} PUCCH resource provided by pucch-ResourceId |
| | obtained from the 8^{th} value of resourceList |

For each UE, only maximum 8 PUCCH resources are allowed to be configured for each PUCCH resource set for larger HARQ-ACK payload, e.g. HARQ-ACK payloads larger than 2 bits.

Configuring each UE with one dedicated PUCCH resource in each PUCCH resource set may secure PUCCH HARQ-ACK resources when the UE is scheduled, which is unrealistic if there are many UE in the cell since the actual utilized PUCCH HARQ-ACK resources will randomly fragment the spectrum which impacts UL traffic.

The impact on Uplink (UL) traffic may be minimized if multiple UEs instead share the same PUCCH resources, but this has the consequence of increased PUCCH HARQ-ACK resource allocation failures, thus preventing downlink scheduling.

A PUCCH HARQ-ACK resource allocation scheme is needed to make sure that PUCCH resources are efficiently utilized and shared between UEs and that a PUCCH HARQ-ACK resource allocation failure rate shall be minimized to ensure DL traffic. Furthermore, a PUCCH HARQ-ACK resource allocation scheme is needed to make sure that PUSCH resource fragmentation shall be minimized to ensure UL traffic.

Therefore, there is a need to at least mitigate or solve these issues.

### SUMMARY

An objective is to obviate at least one of the above disadvantages and to improve handling of PUCCH resources in a communications system.

According to a first aspect, the object is achieved by a method performed by a network node in a communications system for handling PUCCH resources in a frequency spectrum of the communications system. The network node categorizes the PUCCH resources into a plurality of congestion level groups. Each congestion level group in the plurality of congestion level groups is associated with a number of UE in a cell sharing the PUCCH resources. The PUCCH resources categorized in a first congestion level group are shared by a higher number of UE's than in a second congestion level group. The network node assigns the categorized PUCCH resources to different parts of the frequency spectrum. The first congestion level group is assigned to a first part of the frequency spectrum and the PUCCH resources categorized in the second congestion level group are assigned to a second part of the spectrum. The second part is closer to center of the spectrum than the first part. The network node determines that the PUCCH resources categorized in the first congestion level group and assigned to the first part of the frequency spectrum should be used by the UE prior to using the PUCCH resources categorized in the second congestion level group and assigned to the second part of the frequency spectrum.

According to a second aspect, the object is achieved by a network node in a communications system for handling PUCCH resources in the frequency spectrum of the communications system. The network node is configured to categorize the PUCCH resources into a plurality of congestion level groups. Each congestion level group in the plurality of congestion level groups is associated with a number of UEs in a cell sharing the PUCCH resources. The PUCCH resources categorized in a first congestion level group are shared by a higher number of UE's than in a second congestion level group. The network node is configured to assign the categorized PUCCH resources to different parts of the frequency spectrum. The first congestion level group is assigned to a first part of the frequency spectrum and the PUCCH resources categorized in the second congestion level group are assigned to a second part of the frequency spectrum. The second part is closer to center of the frequency spectrum than the first part. The network node is configured to determine that the PUCCH resources categorized in the first congestion level group and assigned to the first part of the frequency spectrum should be used by the UE prior to using the PUCCH resources categorized in the second congestion level group and assigned to the second part of the frequency spectrum.

Since the PUCCH resources are categorized into a plurality of congestion level groups, it is possible to dynamically adjust the PUCCH resource utilization based on the congestion level and thus improving the handling of PUCCH resources in a communications system.

The present disclosure herein affords many advantages, of which a non-exhaustive list of examples follows:

An advantage of the present disclosure is that by categorizing the PUCCH resources by congestion level it is possible to dynamically adjust the PUCCH resource utilization area to the band edge. This may secure a reasonable PUCCH resource allocation success rate at a relatively high load scenario but with less PUCCH resources configured. Furthermore, in a low load scenario, the second congestion level group, i.e. the lower congestion group, will have lower probability of being utilized, which provides a larger contiguous PUCCH spectrum towards to the middle of the frequency band.

Another advantage of the present disclosure is that by allow PUCCH resource sharing between UEs based on priority it is possible to differentiate the PUCCH resource allocation failure rate based on UE QoS class. A higher priority UE will have less conflict when being allocated PUCCH resources. Furthermore, it will balance the competition for UL frequency spectrum between DL transmission feedback and UL-shared data.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings in which:

FIG. 1 is a schematic block diagram illustrating a communications system.

FIG. 2 is a flow chart illustrating a method.

FIG. 3a is a flow chart illustrating a method.

FIG. 3b is a flow chart illustrating a method.

FIG. 4 is a flow chart illustrating a method.

FIG. 5 is a graph illustrating a simulation.

FIG. 6 is a graph illustrating a simulation.

FIG. 7 is a graph illustrating a simulation.

FIG. 8 is a flow chart illustrating a method performed by a network node.

FIG. 9a is a schematic drawing illustrating a network node.

FIG. 9b is a schematic drawing illustrating a network node.

FIG. 10 is a schematic block diagram illustrating a telecommunication network connected via an intermediate network to a host computer.

FIG. 11 is a schematic block diagram of a host computer communicating via a base station with a UE over a partially wireless connection.

FIG. 12 is a flowchart depicting a method in a communications system comprising a host computer, a base station and a UE.

FIG. 13 is a flowchart depicting a method in a communications system comprising a host computer, a base station and a UE.

FIG. 14 is a flowchart depicting a method in a communications system comprising a host computer, a base station and a UE.

FIG. 15 is a flowchart depicting a method in a communications system comprising a host computer, a base station and a UE.

The drawings are not necessarily to scale, and the dimensions of certain features may have been exaggerated for the sake of clarity. Emphasis is instead placed upon illustrating the principle.

### DETAILED DESCRIPTION

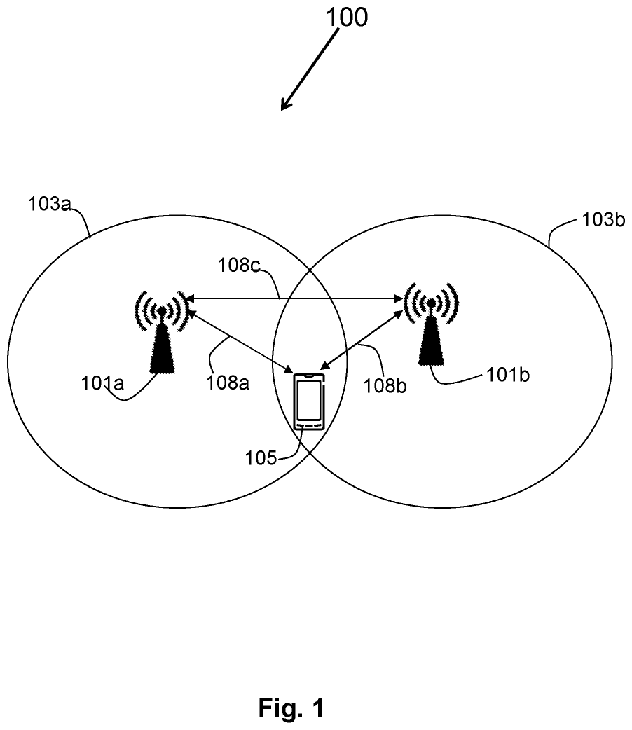

FIG. 1 depicts a communications system 100, which may be a wireless communications system, sometimes also referred to as a wireless communications network, cellular radio system, or cellular network, in which the present disclosure may be implemented. The communications system 100 may be a 5G system, 5G network, NR-U or Next Gen system or network. The communications system 100 may alternatively be a younger system or older system than a 5G system, such as e.g. a 2G system, a 3G system, a 4G system, a 6G system a 7G system etc. The communications system 100 may support other technologies such as, for example, Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, NB-IoT. Thus, although terminology from 5G/NR and LTE may be used in this disclosure to exemplify, this should not be seen as limiting to only the aforementioned systems.

The communications system 100 comprises one or a plurality of network nodes, whereof a first network node 101a and a second network node 101b are depicted in FIG. 1. Any of the first network node 101a, and the second network node 101b may be a radio network node, such as a radio base station, or any other network node with similar features capable of serving a UE, such as a wireless device or a machine type communication device, in the communications system 100. The first network node 101a may be an eNB and the second network node 101b may be a gNB. The first network node 101a may be a first eNB, and the second network node 101b may be a second eNB. The first network node 101a may be a first gNB, and the second network node 101b may be a second gNB. The first network node 101a may be a MeNB and the second network node 101b may be a gNB. Any of the first network node 101a and the second network node 101b may be co-localized, or they may be part of the same network node. The first network node 101a may be referred to as a source node or source network node, whereas the second network node 101b may be referred to as a target node or target network node. When the reference number 101 is used herein without the letters a or b, it refers to a network node in general, i.e. it refers to any of the first network node 101a or second network node 101b.

The communications system 100 covers a geographical area which may be divided into cell areas, wherein each cell area may be served by a network node, although, one network node may serve one or several cells. In FIG. 1, the communications system 100 comprises a first cell 103a and a second cell 103b. Note that two cells are exemplified in FIG. 1 only as an example, and that any n number of cells may be comprised in the communication system 100, where n is any positive integer. A cell is a geographical area where radio coverage is provided by the network node at a network node site. Each cell is identified by an identity within the local network node area, which is broadcast in the cell. In FIG. 1, first network node 101a serves the first cell 103a, and the second network node 101b serves the second cell 103b. Any of the first network node 101a and the second network node 101b may be of different classes, such as, e.g., macro base station (BS), home BS or pico BS, based on transmission power and thereby also cell size. Any of the first network node 101a and the second network node 101b may be directly connected to one or more core networks, which are not depicted in FIG. 1 for the sake of simplicity. Any of the first network node 101a and the second network node 101n may be a distributed node, such as a virtual node in the cloud, and it may perform its functions entirely on the cloud, or partially, in collaboration with another network node. The first cell 103a may be referred to as a source cell, whereas the second cell 103b may be referred to as a target cell. When the reference number 103 is used herein without the letters a or b, it refers to a cell in general, i.e. it refers to any of the first cell 103a or second cell 103b.

One or a plurality of UEs 105 is comprised in the communication system 100. Only one UE 105 is exemplified in FIG. 1 for the sake of simplicity. A UE 105 may also be referred to simply as a device. The UE 105, e.g. a LTE UE or a 5G/NR UE, may be a wireless communication device which may also be known as e.g., a wireless device, a mobile terminal, wireless terminal and/or mobile station, a mobile telephone, cellular telephone, or laptop with wireless capability, just to mention some examples. The UE 105 may be a device by which a subscriber may access services offered by an operator's network and services outside operator's network to which the operator's radio access network and core network provide access, e.g. access to the Internet. The UE 105 may be any device, mobile or stationary, enabled to communicate over a radio channel in the communications system 100, for instance but not limited to e.g. UE, mobile phone, smart phone, sensors, meters, vehicles, household appliances, medical appliances, media players, cameras, Machine to Machine (M2M) device, Internet of Things (IoT) device, terminal device, communication device or any type of consumer electronic, for instance but not limited to television, radio, lighting arrangements, tablet computer, laptop or Personal Computer (PC). The UE 105 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in the communications system 100.

The UE 105 is enabled to communicate wirelessly within the communications system 100. The communication may be performed e.g. between two UEs 105, between a UE 105 and a regular telephone, between the UE 105 and a network node, between network nodes 101, and/or between the UE 105 and a server via the radio access network and possibly one or more core networks and possibly the internet.

The first network node 101a may be configured to communicate in the communications system 100 with the UE 105 over a first communication link 108a, e.g., a radio link. The second network node 101b may be configured to communicate in the communications system 100 with the UE 105 over a second communication link 108b, e.g., a radio link. The first network node 101a may be configured to communicate in the communications system 100 with the second network node 101b over a third communication link 108c, e.g., a radio link or a wired link, although communication over more links may be possible. When the reference number 108 is used herein without the letters a, b or c, it refers to a communication link in general, i.e. it refers to any of the first communication link 108a, the second communication link 108b and the third communication link 108c.

It should be noted that the communication links 108 in the communications system 100 may be of any suitable kind comprising either a wired or wireless link. The link may use any suitable protocol depending on type and level of layer (e.g. as indicated by the Open Systems Interconnection (OSI) model) as understood by the person skilled in the art.

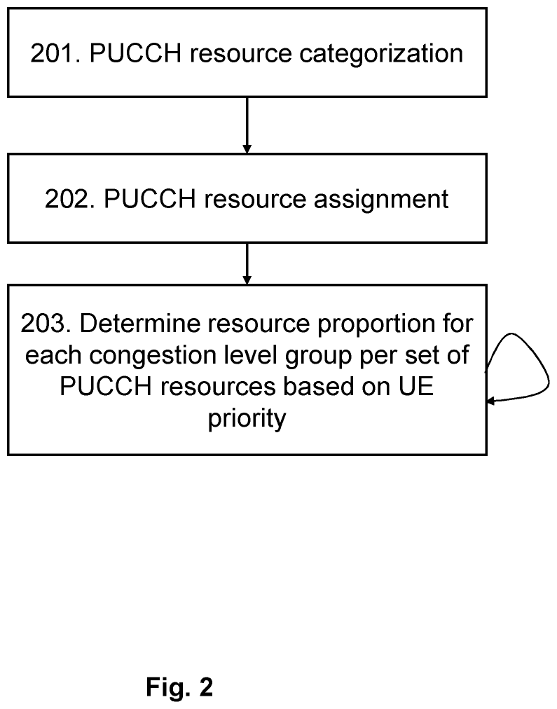

The method for handling PUCCH resources in a frequency spectrum of the communications system 100 will now be described with reference to the flowchart depicted in FIG. 2. The method comprises at least one of the following steps, which steps may as well be carried out in another suitable order than described below.

### Step 201

The network node 101 performs a PUCCH resource categorization based on congestion level. Using other words, the network node 101 categorizes the PUCCH resources into a plurality of congestion level groups, e.g. a first congestion level group and a second congestion level group. There may be a plurality of PUCCH resources that are adaptable to be categorized by the network node 101. The PUCCH resources may be PUCCH HARQ-ACK resources or it may be Semi-Persistent Channel State Information, SP CSI.

A pre-requisite for the categorization may be that the network node 101 has obtained information about the PUCCH resources, i.e. available PUCCH resources. The information may be obtained by being preconfigured in the network node 101, by being obtained upon request by the network node 101 e.g. from another network node, from a storage memory such as for example a local memory or a cloud memory, by being obtained by being sent to the network node 101 or obtained by any other suitable means.

Each congestion level group in the plurality of congestion level groups is associated with a number of UE 105 in a cell 103 sharing the PUCCH resources. Thus, the level of congestion is associated with how many UEs 105 in a certain cell 103 that shares the PUCCH resources.

There may be at least two congestion level groups, e.g. a first congestion level group and a second congestion level group. Note that two congestion level groups are only used as an example and that there may be any n number of congestion level groups, where n is a positive integer.

The PUCCH resources categorized in a first congestion level group are shared by a higher number of UE's 105 than in a second congestion level group. The first congestion level group may be a higher congestion level group and the second congestion level group may be a lower congestion level group, where high and low refers to the congestion level.

The congestion level group may be a congestion level resource group or a congestion level PUCCH resource group.

### Step 202

A PUCCH resource assignment may be performed on the network side. Using other words, the network node 101 may assign the categorized PUCCH resources from step 201 to different parts of the frequency spectrum. Assigning the categorized PUCCH resources may be described as allocating the categorized PUCCH resources.

The first congestion level group may be assigned to a first part of the frequency spectrum. The PUCCH resources categorized in the second congestion level group may be assigned to a second part of the spectrum. The second part may be closer to center of the spectrum than the first part. The first part may be an edge part and the second part may be a middle part, or the first part may be a middle part and the second part may be an edge part, or the first part may be a left edge part and the second part may be a right edge part, or both the first part and the second part may be at the middle of the frequency band etc. It may be advantageous to keep the second part, e.g. the middle part of the frequency spectrum, as empty as possible to enable large consecutive PUSCH allocations.

For example, the first congestion level group, e.g. a higher congestion level group, may be assigned towards the edge of the frequency band, and the second congestion level group, e.g. a lower congestion level group may be assigned towards to the middle of the frequency band.

### Step 203

A UE configuration for a particular UE 105 may be performed which may comprise to determine the PUCCH resource proportion for each resource group per set of PUCCH resource based on UE priority. The PUCCH resource proportion may be associated with a number or an amount of PUCCH resources. Using other words, the network node 101 may determine, based on the UE priority, a number of PUCCH resources per set of PUCCH resources set from each congestion level group of the plurality of congestion level groups to be used by the UE 105.

The UE priority may be associated with QoS class in which the UE is classified. QoS may associated with one or more parameters such as e.g. packet loss, bit rate, throughput, transmission delay, etc. QoS is flow based in 5G, and bearer based in 4G.

Thus, based on UE priority, e.g. QoS class, the network node 101 may determine the number of PUCCH resources from each resource group. Lower priority UE 105 may get more PUCCH resources from a higher congestion group, and a higher priority UE 105 may get more resources from a lower congestion group.

A prerequisite for step 203 may be that the network node 101 obtains information indicating the UE priority. The information may be obtained by being preconfigured in the network node 101, by being obtained upon request by the network node 101 e.g. from another network node, from a storage memory such as for example a local memory or a cloud memory, by being obtained by being sent to the network node 101 or obtained by any other suitable means. The UE priority may be of any suitable format. For example, a UE 105 with a UE priority in the range of 0-5 may be a low priority UE 105 and a UE 105 with a UE priority in the range of 10-16 may be a high priority UE 105.

The set of PUCCH resources may referred to as a PUCCH resource set. The set of PUCCH resources may be associated with one or more of HARQ, HARQ ACK and SP-CSI. A set of PUCCH resources comprises an n number of PUCCH resources (n is a positive integer) or a group of PUCCH resources, where the PUCCH resources may be one or more of HARQ, HARQ ACK and SP-CSI. Each UE 105 may be configured with up to 4 PUCCH resources for SP-CSI, and from the network node side, it is possible to configure multi-UE on the same PUCCH resource, and the network node 101 may determine which UE 105 that may use a certain PUCCH resource at a certain time period.

The number of PUCCH resources is determined for each UE 105 and the number may be for each UE 105. There may be a maximum number of PUCCH resource limitation for each UE 105.

Step 203 may be performed per UE 105, as indicated with the arrow to the right of box 203 in FIG. 2, such that step 203 may be repeated for each new UE 105 connected to the cell 103 or for each reconfigured UE.

After step 203, the network node 101 determines that PUCCH resources in the first congestion level should be used by a UE 105 prior to PUCCH resources in the second congestion level group.

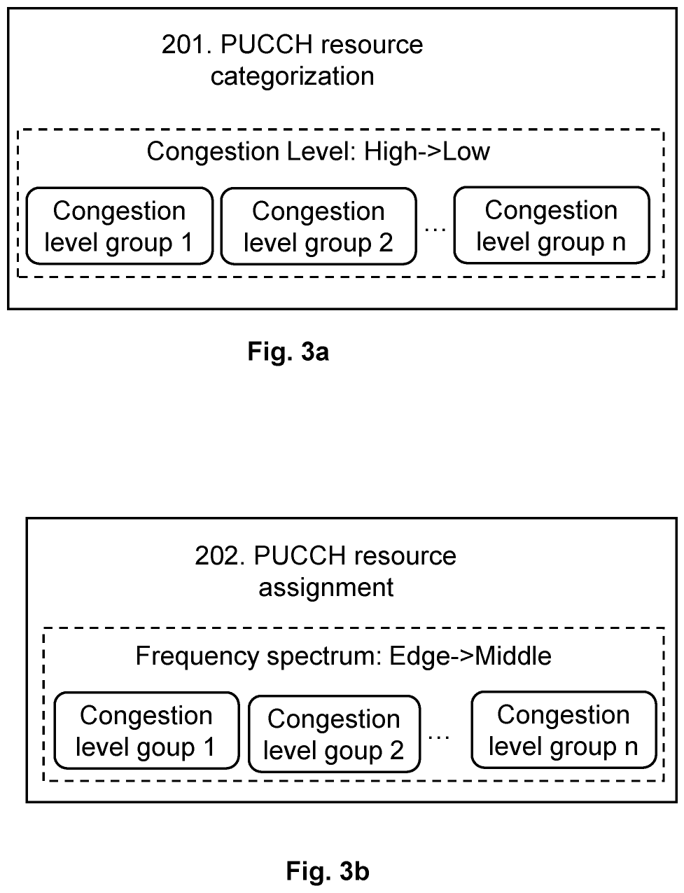

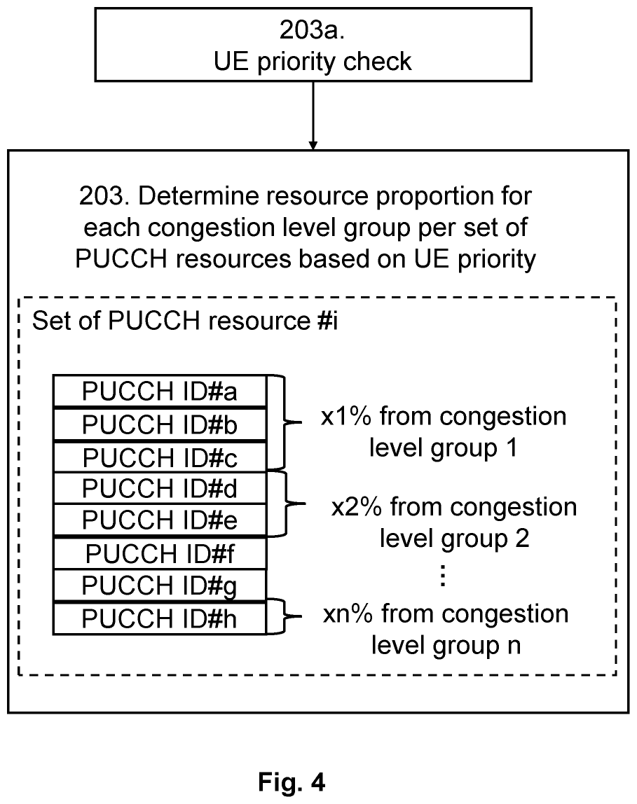

Some of the steps illustrated in FIG. 2 will now be described in more detail with reference to FIG. 3a, FIG. 3b and FIG. 4. FIG. 3a illustrates steps 201, FIG. 3b illustrates step 202 and FIG. 4 illustrates step 203.

Starting with FIG. 3a. In step 201, the network node 101 categorizes the PUCCH resources based on congestion levels, i.e. it categorizes the PUCCH resources into a plurality of congestion level groups. As exemplified in FIG. 3a, there may be n number of congestion level groups, where n is a positive integer. The congestion level group may be referred to as a resource group or a PUCCH resource group. Congestion level group 1 may be associated with a congestion level 1, congestion level group 2 may be associated with a congestion level 2 and congestion level group n may be associated with congestion level n. The congestion level 1 may be a higher congestion level than congestion level 2, and congestion level n may be a lower congestion level than congestion levels 1 and 2. The congestion level groups may be numbered in an increasing fashion such that the congestion level decreases with increasing numbering of the congestion level group.

Moving on to FIG. 3b which illustrates step 202. In step 202, the network node 101 may perform an PUCCH resource assignment. Using other words, the network node 101 may perform PUCCH resource allocation. The PUCCH resource assignment may be a PRB index assignment. When performing the PUCCH resource assignment, the network node 101 assigns the categorized PUCCH resources to different parts of the frequency spectrum. As exemplified in FIG. 3b, congestion level group 1 may be assigned to an left edge part of the frequency spectrum, congestion level group 2 may be assigned to a part of the frequency spectrum next to congestion level group 1 and closer to the middle, and congestion level group n may be assigned to a left edge part of the frequency spectrum. The higher number of the congestion level group, the closer to the middle of the frequency band the congestion level group may be assigned. For example, there may be 273 PRBs and the first part may be PRB0-1 and the second part may be PRB 2-3. PUCCH resources with a lower PRB index may be used first, and higher PRB index may be used after the lower PRB index.

FIG. 4 illustrates step 203 which may be that the network node 101 may determine a resource proportion for each congestion level group per set of PUCCH resources based on UE priority. As exemplified in FIG. 4, a step 203a may be performed before step 203 and may comprise that the network node 101 performs a check of the UE priority, i.e. the network node 101 may obtain the UE priority or may determine the UE priority. Step 203a may be a substep of step 203 or it may be a step performed before step 203.

The steps illustrated in FIG. 4 may be performed for each UE 105, i.e. it may be repeated for each new UE 105 connecting to the cell 103 or reconnecting to the cell 103, i.e. at UE setup. This is different compared to steps 201 and 202 which may be performed once, e.g. at cell setup, i.e. they may not be repeated.

FIG. 4 illustrates an example with i sets of PUCCH resources. Each set may be identified with an identity (ID), e.g. ID #a, ID #b, ID #c etc. FIG. 4 provides an example of a set of PUCCH resources comprising 8 PUCCH resources. For the set of PUCCH resources exemplified in FIG. 4, 3 of the 8 PUCCH resources, i.e. 37.5%, in the set of PUCCH resources from congestion level group 1 may be used by a UE 105 with UE priority 1, e.g. PUCCH ID #a, PUCCH ID #b and PUCCH ID #c. 2 of the 8 PUCCH resources, i.e. 25%, in the set of the PUCCH resources from congestion level group 2 may be used by a UE 105 with UE priority 2, e.g. PUCCH ID #c and PUCCH ID #d. Note that FIG. 4 is an example of a set of PUCCH resources with maximum 8 PUCCH resources. The total number of PUCCH resources in a set of PUCCH resources may be be different, for example maximum 4 for SP-CSI, or maximum 32 for a special PUCCH HARQ-ACK resource set 0. PUCCH resource set 0 is a special one specified by standard, which allows to have maximum 32 HARQ-ACK resources depends on configuration.

When the network node 101 may assign the categorized PUCCH resources as described above, within each set of PUCCH resource set, the network node 101 may assign a lower PUCCH resource index first. In this way, a higher congestion level group may be scheduled earlier than a lower congestion level group by the network node 101. The PUCCH resource from the lowest congestion level group will have the lowest probability to be utilized.

When the traffic load has increased, PUCCH resources from a lower congestion level group may be started to be utilized, and the PUCCH resource assignment success rate of a higher priority UE 105 may be maintained in a demanded level. When the traffic load has decreased at the very low level, all the PUCCH resource from a lower congestion level group may not be utilized, so all those PUCCH resources that are assigned towards the middle part of the frequency spectrum may form a contiguous spectrum with dedicated PUSCH resources, which may be used to achieve higher single UE throughput.

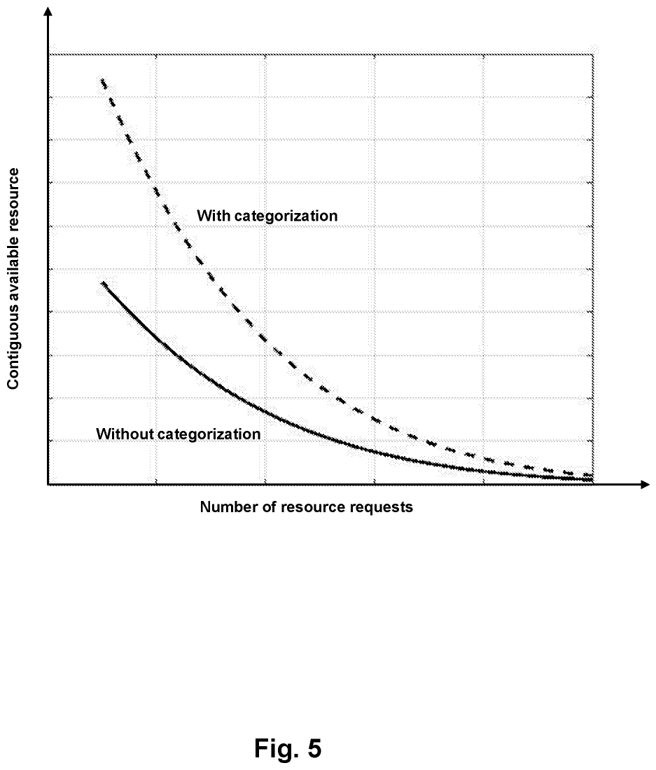

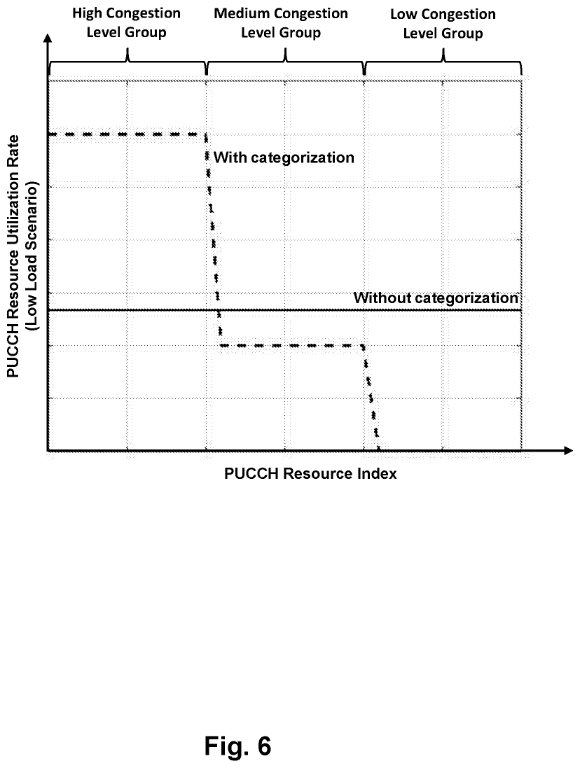

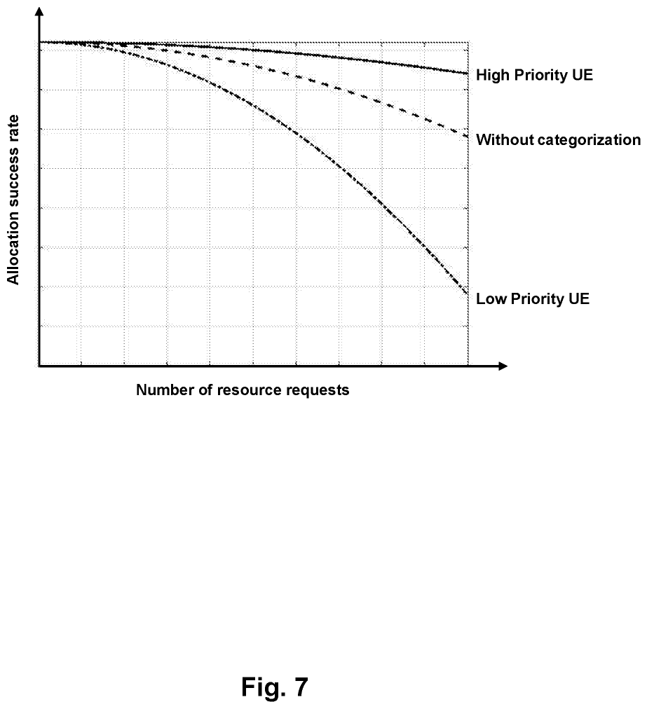

Some simulations will now be described. The simulations are based on the following assumptions:
30 PUCCH resources configured for set 1 of PUCCH resources, only PUCCH resource set 1 assumed for a payload bit larger than 2 bits.
3 congestion level groups and 10 PUCCH resources for each congestion level group.
For low priority UE, configure 5, 2, 1 PUCCH resource(s) from each congestion level group; for high priority UE, configure 2, 2, 4 PUCCH resources from each congestion level group.
For simulations in FIG. 5 and FIG. 6, all UEs are configured as low priority UE. For the simulation in FIG. 7, 90% of the UEs are low priority UE, and 10% are high priority UE.

FIG. 5 is a graph illustrating a simulation of contiguous available PUCCH resources (y-axis) versus a number of PUCCH resource requests (x-axis). The dotted line illustrates with categorization, i.e. when step 201 is performed, and the solid line illustrates without categorization, i.e. when step 201 is not performed. The solid line illustrates a scenario without the present disclosure, i.e. as according to the prior art. As seen in FIG. 5, when the traffic load is low, the more contiguous PUCCH resource adjacent to PUSCH may be used for contiguous PUSCH transmission. When the traffic load is high, there is no big difference regarding PRB saving and/or/sharing, and most PUCCH resources are used to secure allocation success rate.

FIG. 6 is a graph illustrating a simulation of PUCCH resource utilization rate (y-axis) versus PUCCH resource index (x-axis). The dotted line illustrates with categorization, i.e. when step 201 is performed, and the solid line illustrates without categorization, i.e. when step 201 is not performed. The solid line illustrates a scenario without the present disclosure, i.e. as according to the prior art. The high congestion level group is seen to the left, the medium congestion group is in the middle and the low congestion level group is seen to the right in FIG. 6. As seen in FIG. 6, without categorization, all PUCCH HARQ resources have the similar utilization rate, as illustrated by the horizontal solid line. With categorization, after step 201 has been performed, a congestion level group associated with a higher congestion level will be utilized first. A lower congestion level group has lower utilization which may help saving more PUCCH PRBs than can be used for PUSCH transmission.

FIG. 7 is a graph illustrating a simulation of allocation success rate (y-axis) versus a number of resource request (x-axis). The solid line represents a high priority UE. The middle dotted line represents without categorization, i.e. when step 201 is not performed and as in the prior art. The bottom dotted line represents a low priority UE 105. As seen from FIG. 7, when introducing different QoS class for different UEs 105, there is no allocation success rate difference without categorization. With categorization, i.e. when step 201 is performed, a high priority UE 105 may be maintained with high allocation success rate. While a low priority UE 105 may have lower success rate as a consequence of securing transmission of high priority UE 105.

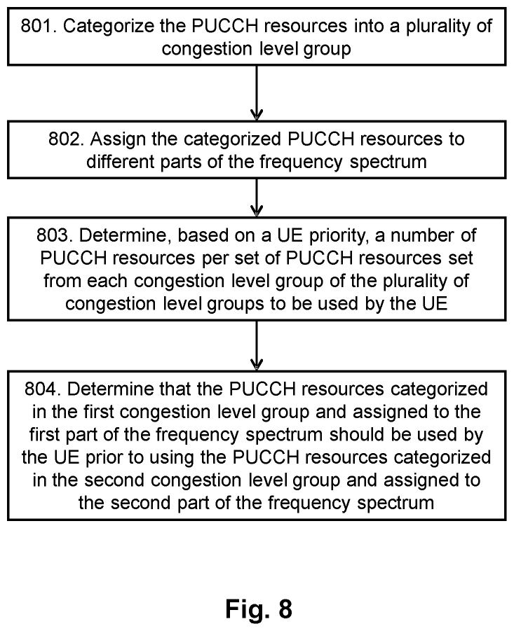

The method described above will now be described seen from the perspective of the network node 101. FIG. 8 is a flowchart describing the present method in the network node 101 for handling PUCCH resources in a frequency spectrum of the communications system 100. The network node 101 may be a base station, an access node, a radio access node or a gNodeB. The method comprises at least one of the following steps to be performed by the network node 101, which steps may be performed in any suitable order than described below:

### Step 801

This step corresponds to step 201 in FIG. 2. The network node 101 categorizes the PUCCH resources into a plurality of congestion level groups. Each congestion level group in the plurality of congestion level groups is associated with a number of UEs 105 in a cell 103 sharing the PUCCH resources. The PUCCH resources categorized in a first congestion level group are shared by a higher number of UE's 105 than in a second congestion level group.

The PUCCH resources may be associated with PUCCH HARQ ACK or associated with SP CSI.

Step 801 may be performed any time, at cell setup or at a first time using any of the first congestion level group and the second congestion level group. Using other words, step 801 may be triggered by any suitable trigger such as e.g. a cell setup. In a cell 103 without any active UEs 105, step 801 may be performed any time. Step 801 may be triggered by opening up a new congestion level group for example if the first congestion level group is heavily loaded.

### Step 802

This step corresponds to step 202 in FIG. 2. The network node 101 assigns the categorized PUCCH resources to different parts of the frequency spectrum. The first congestion level group may be assigned to a first part of the frequency spectrum and the PUCCH resources categorized in the second congestion level group may be assigned to a second part of the spectrum. The second part may be closer to center or middle of the spectrum than the first part.

Step 802 may be performed any time, at cell setup or at a first time using any of the first congestion level group and the second congestion level group. Using other words, step 802 may be triggered by any suitable trigger such as e.g. a cell setup. In a cell 103 without any active UEs 105, step 802 may be performed any time. Step 802 may be triggered by opening up a new congestion level group for example if the first congestion level group is heavily loaded.

The step of assign the categorized PUCCH resources to different parts of the frequency spectrum may comprise that the network node 101 assigns a first PRB index or a first set of PRB index to the PUCCH resources categorized in the first congestion level group, and that the network node 101 assigns a second PRB index or a second set of PRB index to the PUCCH resources categorized in the second congestion level. The first PRB index and the first set of PRB index may be lower than the second PRB and the second set of PRB index

### Step 803

This step corresponds to step 203 in FIG. 2. The network node 101 may determine, based on a UE priority, a number of PUCCH resources per set of PUCCH resources from each congestion level group of the plurality of congestion level groups to be used by the UE 105. The number of PUCCH resources per set may be a number such as e.g. 4 resources or it may be a percentage of the total amount of PUCCH resources per set.

Step 803 may be performed any time or at UE setup. Step 804 may be repeated for each UE 105 that connects or reconnects to the cell 103. There may be one setup per UE 105, and UEs 105 may be connected to the cell 103 at different time. Each UE 105 may be configured and/or modified at any time.

Step 803 may be performed for each UE 105 that is connected to or reconfigured in the cell 103.

### Step 804

The network node 101 determines that the PUCCH resources categorized in the first congestion level group and assigned to the first part of the frequency spectrum should be used by the UE 105 prior to using the PUCCH resources categorized in the second congestion level group and assigned to the second part of the frequency spectrum.

The determining in step 804 may be further based on UE priority, after step 803 has been performed. The UE priority may be associated with a QoS class of the UE 105. The QoS class may be associated with a QoS Class Identifier (QCI), a 5G QoS Identifier (5QI) or any other suitable QoS class parameter.

A first number of PUCCH resources may be determined to be used by the UE 105 when it has a first UE priority. A second number of PUCCH resources may be determined to be used by the UE 105 when it has a second UE priority. The first number may be higher than the second number, and the first UE priority may be higher than the second UE priority.

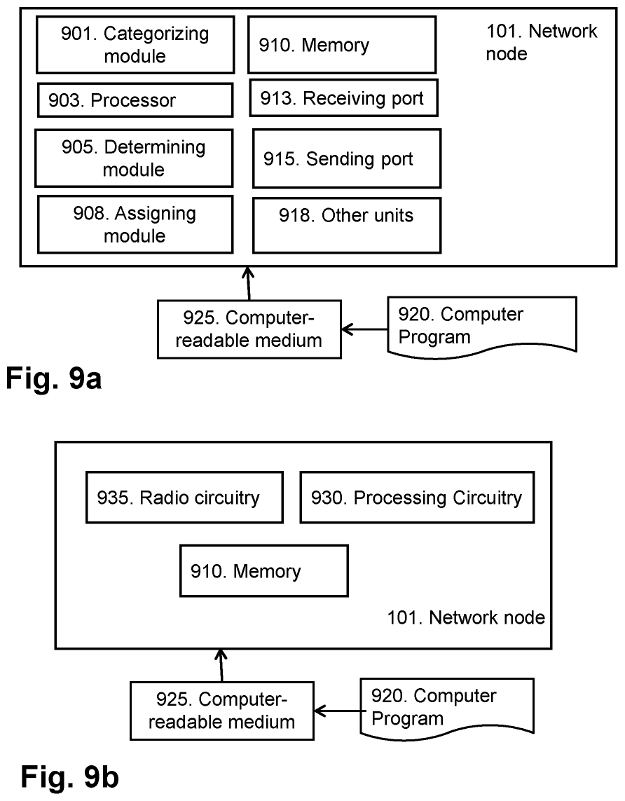

To perform the method steps shown in FIGS. 2, 3a, 3b, 4 and 8, the network node 101 may comprises an arrangement as shown in at least one of FIG. 9a and FIG. 9b. FIG. 9a and FIG. 9b depict two different examples in panels a) and b), respectively, of the arrangement that the network node 101 may comprise. The network node 101 may be a base station, an access node, a radio access node or a gNodeB.

The network node 101 may comprise the following arrangement depicted in FIG. 9a.

The network node 101 is configured to, e.g. by means of a categorizing module 901, categorize the PUCCH resources into a plurality of congestion level groups. Each congestion level group in the plurality of congestion level groups is associated with a number of UEs 105 in a cell 103 sharing the PUCCH resources. The PUCCH resources categorized in a first congestion level group are shared by a higher number of UE's 105 than in a second congestion level group. The network node 101 may be configured to categorize the PUCCH resources into a plurality of congestion level groups at any time, at cell setup or at a first time using any of the first congestion level group and the second congestion level group. The PUCCH resources may be associated with PUCCH HARQ ACK or associated with SP CSI. The categorizing module 901 may also be referred to as a categorizing unit, a categorizing means, a categorizing circuit, means for categorizing etc. The categorizing module 901 may be a processor 903 of the network node 101 or comprised in the processor 903 of the network node 101

The network node 101 is configured to, e.g. by means of a determining module 905, determine that the PUCCH resources categorized in the first congestion level group and assigned to the first part of the frequency spectrum should be used by the UE 105 prior to using the PUCCH resources categorized in the second congestion level group and assigned to the second part of the frequency spectrum. A first number of PUCCH resources may be determined to be used by the UE 105 when it has a first UE priority, a second number of PUCCH resources may be determined to be used by the UE 105 when it has a second UE priority, and the first number may be higher than the second number, and the first UE priority is higher than the second UE priority. The determining module 905 may also be referred to as a determining unit, a determining means, a determining circuit, means for determining etc. The determining module 905 may be the processor 903 of the network node 101 or comprised in the processor 903 of the network node 101

The network node 101 is configured to, e.g. by means of an assigning module 908, assign the categorized PUCCH resources to different parts of the frequency spectrum. The first congestion level group is assigned to a first part of the frequency spectrum and the PUCCH resources categorized in the second congestion level group is assigned to a second part of the frequency spectrum. The second part may be closer to center of the frequency spectrum than the first part. The network node 101 may be configured to perform the assigning of the PUCCH resources categorized to the frequency spectrum at any time, at cell setup or at a first time using any of the first congestion level group and the second congestion level group. The assigning module 908 may also be referred to as an assigning unit, an assigning means, an assigning circuit, means for assigning etc. The assigning module 908 may be the processor 903 of the network node 101 or comprised in the processor 903 of the network node 101

The network node 101 may be configured to, e.g. by means of the determining module 905, determine, based on a UE priority, a number of PUCCH resources per set of PUCCH resources from each congestion level group of the plurality of congestion level groups to be used by the UE 105. The network node 101 may be configured to determine, based on the UE priority, the number of PUCCH resources per set of PUCCH resources from each congestion level group of the plurality of congestion level groups to be used by the UE 105 at any time or at UE setup. The UE priority may be associated with a QoS class of the UE 105. The network node 101 may be configured to to perform the determining, based on the UE priority, a number of PUCCH resources per set of PUCCH resources from each congestion level group of the plurality of congestion level groups to be used by the UE 105 for each UE 105 that is connected to or reconfigured in the cell 103.

The network node 101 may be configured to, e.g. by means of the assigning module 908, assign a first PRB index or a first set of PRB index to the PUCCH resources categorized in the first congestion level group, and to assign a second PRB index or a second set of PRB index to the PUCCH resources categorized in the second congestion level group. The first PRB index and the first set of PRB index may be lower than the second PRB and the second set of PRB index.

The present disclosure associated with the network node 101 may be implemented through one or more processors, such as a processor 903 in the network node 101 depicted in FIG. 9a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the network node 101. One such carrier may be in the form of a CD ROM disc. It is however feasible with other data carriers such as a memory stick. The computer program code may be provided as pure program code on a server and downloaded to the network node 101.

The network node 101 may comprise a memory 910 comprising one or more memory units. The memory 910 is arranged to be used to store obtained information, store data, configurations, schedulings, and applications etc. to perform the methods herein when being executed in the network node 101.

The network node 101 may receive information from, e.g., the UE 105, through a receiving port 913. The receiving port 913 may be, for example, connected to one or more antennas in network node 101. The network node 101 may receive information from another structure in the communications system 100 through the receiving port 913. Since the receiving port 913 may be in communication with the processor 903, the receiving port 913 may then send the received information to the processor 2001. The receiving port 913 may also be configured to receive other information.

The processor 903 in the network node 101 may be configured to transmit or send information to e.g., the UE 105, or another structure in the communications system 100, through a sending port 915, which may be in communication with the processor 903, and the memory 910.

The network node 101 may comprise the categorizing module 901, the determining module 905, the assigning module 908 and other module(s) 918 etc.

Those skilled in the art will also appreciate that the categorizing module 901, the determining module 905, the assigning module 908 and other module(s) 918 etc. described above may refer to a combination of analog and digital circuits, and/or one or more processors configured with software and/or firmware, e.g., stored in memory, that, when executed by the one or more processors such as the processor 903, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

Also, the different units 901, 905, 908, 918 described above may be implemented as one or more applications running on one or more processors such as the processor 903.

Thus, the methods described herein for the network node 101 may be respectively implemented by means of a computer program 920 product, comprising instructions, i.e., software code portions, which, when executed on at least one processor 903, cause the at least one processor 903 to carry out the actions described herein, as performed by the network node 101. The computer program 920 product may be stored on a computer-readable storage medium 925. The computer-readable storage medium 925, having stored thereon the computer program 920, may comprise instructions which, when executed on at least one processor 903, cause the at least one processor 903 to carry out the actions described herein, as performed by the network node 101. The computer-readable storage medium 925 may be a non-transitory computer-readable storage medium, such as a CD ROM disc, or a memory stick. The computer program 920 product may be stored on a carrier containing the computer program 920 just described, wherein the carrier is one of an electronic signal, optical signal, radio signal, or the second computer-readable storage medium 925, as described above.

The network node 101 may comprise a communication interface configured to facilitate communications between the network node 101 and other nodes or devices, e.g., the UE 105, or another structure. The interface may, for example, comprise a transceiver configured to transmit and receive radio signals over an air interface in accordance with a suitable standard.

The network node 101 may comprise the following arrangement depicted in FIG. 9b. The network node 101 may comprise a processing circuitry 930, e.g., one or more processors such as the processor 903, in the network node 101 and the memory 910. The network node 101 may also comprise a radio circuitry 935, which may comprise e.g., the receiving port 913 and the sending port 915. The processing circuitry 930 may be configured to, or operable to, perform the method actions according to FIGS. 2, 3a, 3b, 4, and 8 a similar manner as that described in relation to FIG. 9a. The radio circuitry 935 may be configured to set up and maintain at least a wireless connection with the network node 101. Circuitry may be understood herein as a hardware component.

The network node 101 may be operative to operate in the communications system 100. The network node 101 may comprise the processing circuitry 930 and the memory 910. The memory 910 comprises instructions executable by the processing circuitry 930. The network node 101 is operative to perform the actions described herein in relation to the network node 101, e.g., in FIGS. 2, 3a, 3b, 4, and 8.

Summarized, PUCCH resources are categorized into several groups by different congestion level. For higher congestion level group, each PUCCH resource is shared by several UEs 105. On the contrary, for a lower congestion level group, each PUCCH resource is shared by fewer UE 105.

For PUCCH resource assignment performed by the network node 101, higher congestion level groups may be assigned to a part of the frequency spectrum that may be located closer to the edge. Less congestion level groups may be assigned to a part of the frequency spectrum that may be located closer to the middle of the frequency spectrum.

When the network node 101 allocates PUCCH resources to the UE 105 through the dynamic assignment in the downlink control information it attempts to allocate PUCCH resources in a congestion level group starting from high to low congestion level.

For a UE 105 with different UE priority, e.g. QoS class, a higher priority UE may be configured with more PUCCH resources from the lower congestion level group.

### Further Extensions and Variations

A telecommunication network may be connected via an intermediate network to a host computer.

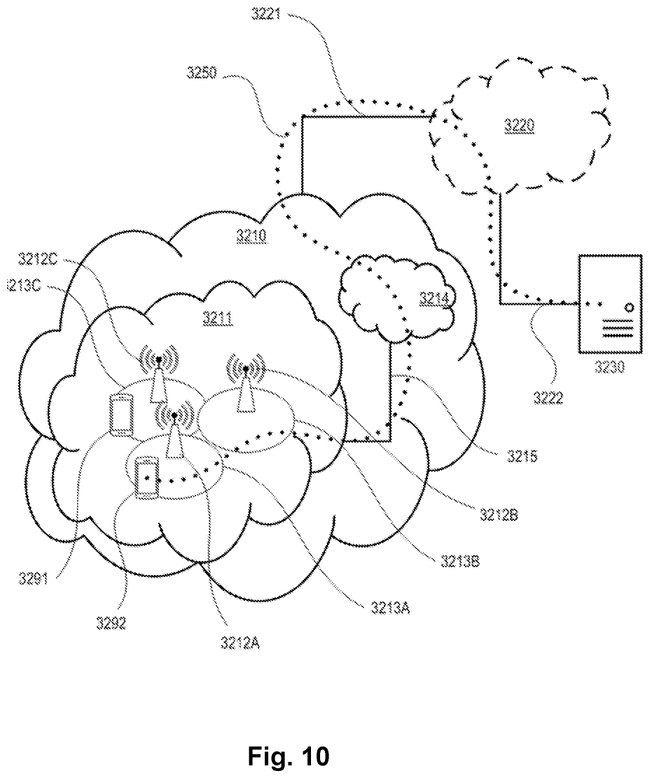

With reference to FIG. 10, a communication system comprises telecommunication network 3210 such as the communications system 100, for example, a 3GPP-type cellular network, which comprises access network 3211, such as a radio access network, and core network 3214. Access network 3211 comprises a plurality of network nodes 101. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of user equipments, such as the UE 105 may be comprised in the communications system 100. In FIG. 10, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, it is equally applicable to a situation where a sole UE is in the coverage area or where a sole UE is connecting to the corresponding base station 3212. Any of the UEs 3291, 3292 may be considered examples of the UE 105.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 10 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

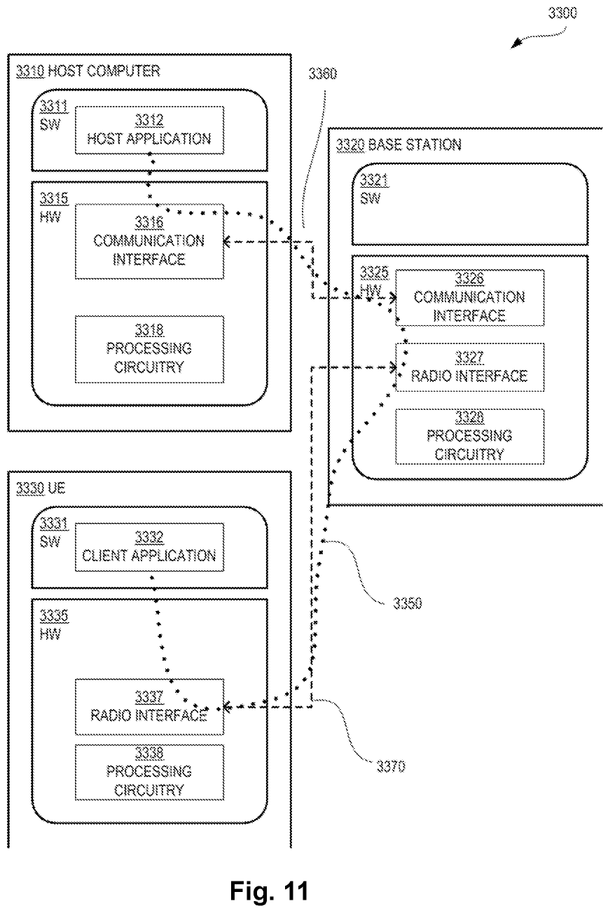

In relation to FIGS. 11-15 which are described next, it may be understood that the base station may be considered an example of the network node 101.

FIG. 11 illustrates an example of host computer communicating via a network node 101 with a UE 105 over a partially wireless connection.

The UE 105 and the network node 101, e.g., a base station and host computer discussed in the preceding paragraphs will now be described with reference to FIG. 11. In communication system 3330, such as the communications system 100, host computer 3310 comprises hardware 3315 comprising communication interface 3316 configured to set up and maintain a wired or wireless connection with an interface of a different communication device of communication system 3300. Host computer 3310 comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 comprises software 3311, which is stored in or accessible by host computer 3310 and executable by processing circuitry 3318. Software 3311 comprises host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 comprises the network node 101 exemplified in FIG. 11 as a base station 3320 provided in a telecommunication system and comprising hardware 3325 enabling it to communicate with host computer 3310 and with UE 3330. Hardware 3325 may comprise communication interface 3326 for setting up and maintaining a wired or wireless connection with an interface of a different communication device of communication system 3300, as well as radio interface 3327 for setting up and maintaining at least wireless connection 3370 with the UE 105, exemplified in FIG. 11 as a UE 3330 located in a coverage area served by base station 3320. Communication interface 3326 may be configured to facilitate connection 3360 to host computer 3310. Connection 3360 may be direct, or it may pass through a core network (not shown in FIG. 11) of the telecommunication system and/or through one or more intermediate networks outside the telecommunication system. Hardware 3325 of base station 3320 comprises processing circuitry 3328, which may comprise one or more programmable processors, application-specific integrated circuits, field programmable gate arrays or combinations of these (not shown) adapted to execute instructions. Base station 3320 has software 3321 stored internally or accessible via an external connection.

Communication system 3300 comprises UE 3330 already referred to. It's hardware 3335 may comprise radio interface 3337 configured to set up and maintain wireless connection 3370 with a base station serving a coverage area in which UE 3330 is currently located. Hardware 3335 of UE 3330 comprises processing circuitry 3338, which may comprise one or more programmable processors, application-specific integrated circuits, field programmable gate arrays or combinations of these (not shown) adapted to execute instructions. UE 3330 comprises software 3331, which is stored in or accessible by UE 3330 and executable by processing circuitry 3338. Software 3331 comprises client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 11 may be similar or identical to host computer 3230, one of base stations 3212a, 3212b, 3212c and one of UEs 3291, 3292 of FIG. 10, respectively. This is to say, the inner workings of these entities may be as shown in FIG. 11 and independently, the surrounding network topology may be that of FIG. 10.

In FIG. 11, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may take decisions by which it dynamically changes the routing, e.g. based on load balancing consideration or reconfiguration of the network.

There may be a wireless connection 3370 between UE 3330 and base station 3320. The present disclosure improves the performance of OTT services provided to UE 3330 using OTT connection 3350, in which wireless connection 3370 forms the last segment. The present disclosure may improve the spectrum efficiency, and latency, and thereby provide benefits such as reduced user waiting time, better responsiveness and extended battery lifetime.

A measurement procedure may be provided for the purpose of monitoring data rate, latency and other factors on which the present disclosure improves. There may be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. Sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may comprise message format, retransmission settings, preferred routing etc.; the reconfiguring need not affect base station 3320, and it may be unknown or imperceptible to base station 3320. Such procedures and functionalities may be known and practiced in the art. Measurements may involve proprietary UE signaling facilitating host computer 3310's measurements of throughput, propagation times, latency and the like. The measurements may be implemented in that software 3311 and 3331 causes messages to be transmitted, in particular empty or dummy messages, using OTT connection 3350 while it monitors propagation times, errors etc.

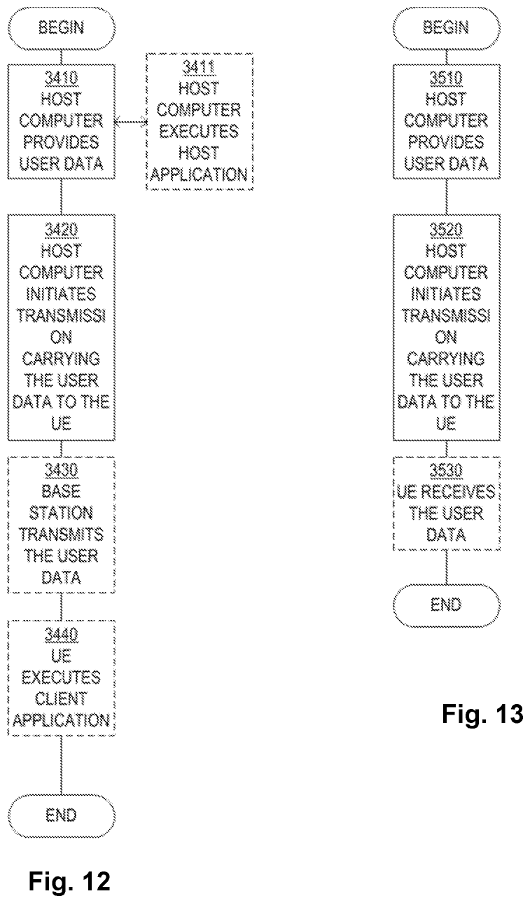

FIG. 12 illustrates an example of methods implemented in a communication system comprising a host computer, a base station and a UE 105. FIG. 12 is a flowchart illustrating a method implemented in a communication system 100. The communication system 100 comprises a host computer, a base station and a UE 105 which may be those described with reference to FIG. 10 and FIG. 11. For simplicity of the present disclosure, only drawing references to FIG. 12 will be comprised in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits, to the UE 105, the user data which was carried in the transmission that the host computer initiated. In step 3440 (which may also be optional), the UE executes a client application associated with the host application executed by the host computer.

FIG. 13 illustrates methods implemented in a communication system comprising a host computer, a base station and a UE 105. FIG. 13 is a flowchart illustrating a method implemented in a communication system 100. The communication system 100 comprises a host computer, a base station and a UE 105 which may be those described with reference to FIG. 10 and FIG. 11. For simplicity of the present disclosure, only drawing references to FIG. 13 will be comprised in this section. In step 3510 of the method, the host computer provides user data. In an optional substep (not shown) the host computer provides the user data by executing a host application. In step 3520, the host computer initiates a transmission carrying the user data to the UE 105. The transmission may pass via the base station. In step 3530 (which may be optional), the UE 105 receives the user data carried in the transmission.

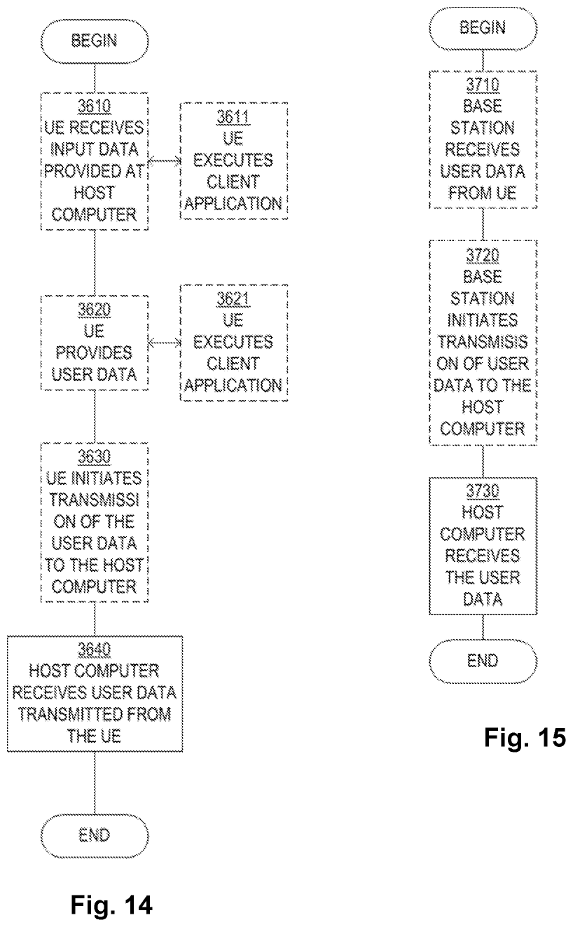

FIG. 14 illustrates methods implemented in a communication system comprising a host computer, a base station and a UE 105. FIG. 14 is a flowchart illustrating a method implemented in a communication system 100. The communication system 100 comprises a host computer, a network node 101 and a UE 105 which may be those described with reference to FIG. 10 and FIG. 11. For simplicity of the present disclosure, only drawing references to FIG. 14 will be comprised in this section. In step 3610 (which may be optional), the UE 105 receives input data provided by the host computer. Additionally, or alternatively, in step 3620, the UE 105 provides user data. In substep 3621 (which may be optional) of step 3620, the UE 105 provides the user data by executing a client application. In substep 3611 (which may be optional) of step 3610, the UE 105 executes a client application which provides the user data in reaction to the received input data provided by the host computer. In providing the user data, the executed client application may consider user input received from the user. Regardless of the specific way the user data was provided, the UE 105 initiates, in substep 3630 (which may be optional), transmission of the user data to the host computer. In step 3640 of the method, the host computer receives the user data transmitted from the UE 105.

FIG. 15 illustrates methods implemented in a communication system comprising a host computer, a base station and a UE 105. FIG. 15 is a flowchart illustrating a method implemented in a communication system 100. The communication system 100 comprises a host computer, a base station and a UE 105 which may be those described with reference to FIG. 10 and FIG. 11. For simplicity of the present disclosure, only drawing references to FIG. 15 will be comprised in this section. In step 3710 (which may be optional), the base station receives user data from the UE 105. In step 3720 (which may be optional), the base station initiates transmission of the received user data to the host computer. In step 3730 (which may be optional), the host computer receives the user data carried in the transmission initiated by the base station.

The present disclosure may be summarized as follows:

A base station is configured to communicate with a UE 105. The base station comprises a radio interface and processing circuitry configured to perform one or more of the actions described herein as performed by the network node 101.

A communication system 100 comprises a host computer, and the communication system 100 comprises:
processing circuitry configured to provide user data; and
a communication interface configured to forward the user data to a cellular network for transmission to a UE 105,
wherein the cellular network comprises a network node 101 having a radio interface and processing circuitry, the base station's processing circuitry configured to perform one or more of the actions described herein as performed by the network node 101.

The communication system 100 may comprise the network node 101.

The communication system 100 may comprise the UE 105. The UE 105 is configured to communicate with the network node 101.

The communication system 101, wherein:
the processing circuitry of the host computer is configured to execute a host application, thereby providing the user data; and
the UE 105 comprises processing circuitry configured to execute a client application associated with the host application.

A method implemented in a network node 101. The method comprises one or more of the actions described herein as performed by the network node 101.

A method implemented in a communication system 100 comprising a host computer, a base station and a UE 105, the method comprising:
at the host computer, providing user data; and
at the host computer, initiating a transmission carrying the user data to the UE 105 via a cellular network comprising the network node 101, wherein the network node 101 performs one or more of the actions described herein as performed by the network node 101.

The method may comprise:
at the network node 101, transmitting the user data.

The user data may be provided at the host computer by executing a host application, and the method may comprise:
at the UE 105, executing a client application associated with the host application.

A UE 105 configured to communicate with a network node 101. The UE 105 comprises a radio interface and processing circuitry configured to perform one or more of the actions described herein as performed by the UE 105.

A communication system 100 comprises a host computer. The communication system 100 comprises:
processing circuitry configured to provide user data; and
a communication interface configured to forward user data to a cellular network for transmission to a UE 105,
wherein the UE 105 comprises a radio interface and processing circuitry, the UE's processing circuitry configured to perform one or more of the actions described herein as performed by the UE 105.

The communication system 100 may comprise the UE 105.

The communication system 100, wherein the cellular network comprises a network node 101 configured to communicate with the UE 105.

The communication system 100, wherein:
the processing circuitry of the host computer is configured to execute a host application, thereby providing the user data; and
the UE's processing circuitry is configured to execute a client application associated with the host application.

A method implemented in a UE 105, comprising one or more of the actions described herein as performed by the UE 105.

A method implemented in a communication system 100 comprising a host computer, a network node 101 and a UE 105, the method comprising:
at the host computer, providing user data; and
at the host computer, initiating a transmission carrying the user data to the UE 105 via a cellular network comprising the base station, wherein the UE 105 performs one or more of the actions described herein as performed by the UE 105.

The method may comprise:
at the UE 105, receiving the user data from the network node 101.

A UE 105 configured to communicate with a network node 101, the UE 105 comprising a radio interface and processing circuitry configured to perform one or more of the actions described herein as performed by the UE 105.

A communication system 100 comprising a host computer comprising:
a communication interface configured to receive user data originating from a transmission from a UE 105 to a network node 101,
wherein the UE 105 comprises a radio interface and processing circuitry, the UE's processing circuitry configured to: perform one or more of the actions described herein as performed by the UE 105.

The communication system 100 may comprise the UE 105.

The communication system 100 may comprise the network node 101, wherein the network node 101 comprises a radio interface configured to communicate with the UE 105 and a communication interface configured to forward to the host computer the user data carried by a transmission from the UE 105 to the base station.

The communication system 100, wherein:
the processing circuitry of the host computer is configured to execute a host application; and
the UE's processing circuitry is configured to execute a client application associated with the host application, thereby providing the user data.

The communication system 100, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 105, comprising one or more of the actions described herein as performed by the UE 105.

The method may comprise:
providing user data; and
forwarding the user data to a host computer via the transmission to the network node 101.

A method implemented in a communication system 100 comprising a host computer, a network node 101 and a UE 105, the method comprising:
at the host computer, receiving user data transmitted to the network node 101 from the UE 105, wherein the UE 105 performs one or more of the actions described herein as performed by the UE 105.

The method may comprise:
at the UE 105, providing the user data to the network node 101.

The method may comprise:
at the UE 105, executing a client application, thereby providing the user data to be transmitted; and
at the host computer, executing a host application associated with the client application.

The method may comprise:
at the UE 105, executing a client application; and
at the UE 105, receiving input data to the client application, the input data being provided at the host computer by executing a host application associated with the client application,
wherein the user data to be transmitted is provided by the client application in response to the input data.

A network node 101 configured to communicate with a UE 105, the network node 101 comprising a radio interface and processing circuitry configured to perform one or more of the actions described herein as performed by the network node 101.

A communication system 100 comprising a host computer comprising a communication interface configured to receive user data originating from a transmission from a UE 105 to a base station, wherein the network node 101 comprises a radio interface and processing circuitry, the base station's processing circuitry configured to perform one or more of the actions described herein as performed by the network node 101.

The communication system 100 may comprise the network node 101.

The communication system 100 may comprise the UE 105, wherein the UE 105 is configured to communicate with the network node 101.

The communication system 100 wherein:
the processing circuitry of the host computer is configured to execute a host application;
the UE 105 is configured to execute a client application associated with the host application, thereby providing the user data to be received by the host computer.

A method implemented in a network node 101, comprising one or more of the actions described herein as performed by any of the network node 101.

A method implemented in a communication system comprising a host computer, a network node 101 and a UE 105, the method comprising:
at the host computer, receiving, from the network node 101, user data originating from a transmission which the base station has received from the UE 105, wherein the UE 105 performs one or more of the actions described herein as performed by the UE 105.

The method may comprise:
at the network node 101, receiving the user data from the UE 105.

The method may comprise:
at the network node 101, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

1. A method performed by a network node in a communications system for handling Physical Uplink Control Channel, PUCCH resources in a frequency spectrum of the communications system, the method comprising:
categorizing the PUCCH resources into a plurality of congestion level groups, wherein each congestion level group in the plurality of congestion level groups is associated with a number of User Equipment's, UE, in a cell sharing the PUCCH resources, wherein the PUCCH resources categorized in a first congestion level group are shared by a higher number of UE's than in a second congestion level group;
assigning the categorized PUCCH resources to different parts of the frequency spectrum, wherein the first congestion level group is assigned to a first part of the frequency spectrum and the PUCCH resources categorized in the second congestion level group are assigned to a second part of the spectrum, wherein the second part is closer to center of the spectrum than the first part; and
determining that the PUCCH resources categorized in the first congestion level group and assigned to the first part of the frequency spectrum should be used by the UE prior to using the PUCCH resources categorized in the second congestion level group and assigned to the second part of the frequency spectrum.

2. The method according to claim 1, comprising:
determining, based on a UE priority, a number of PUCCH resources per set of PUCCH resources from each congestion level group of the plurality of congestion level groups to be used by the UE.

3. The method according to claim 1, wherein the categorizing the PUCCH resources into a plurality of congestion level groups is performed any time, at cell setup or at a first time using any of the first congestion level group and the second congestion level group.

4. The method according to claim 1, wherein the assigning the PUCCH resources categorized to the frequency spectrum are performed any time, at cell setup or at a first time using any of the first congestion level group and the second congestion level group.

5. The method according to claim 2, wherein the determining, based on the UE priority, a number of PUCCH resources per set of PUCCH resources from each congestion level group of the plurality of congestion level groups to be used by the UE is performed any time or at UE setup.

6. The method according to claim 1, wherein the assigning the PUCCH resources categorized to different parts of the frequency spectrum comprises:
assigning a first Physical Resource Block, PRB, index or a first set of PRB index to the PUCCH resources categorized in the first congestion level group; and
assigning a second PRB index or a second set of PRB index to the PUCCH resources categorized in the second congestion level group.

7. The method according to claim 6, wherein the first PRB index and the first set of PRB index are lower than the second PRB and the second set of PRB index.

8. The method according to claim 2, wherein a first number of PUCCH resources is determined to be used by the UE when it has a first UE priority,
and wherein a second number of PUCCH resources is determined to be used by the UE when it has a second UE priority,
wherein the first number is higher than the second number, and the first UE priority is higher than the second UE priority.

9. The method according to claim 2, wherein the UE priority is associated with a Quality of Service, QoS, class of the UE.

10. The method according to claim 1, wherein the PUCCH resources are associated with PUCCH Hybrid Automatic Repeat Request Acknowledgement, HARQ ACK or associated with Semi-Persistent Channel State Information, SP CSI.

11. The method according to claim 2, wherein the determining, based on the UE priority, a number of PUCCH resources per set of PUCCH resources from each congestion level group of the plurality of congestion level groups to be used by the UE is performed for each UE that is connected to or reconfigured in the cell.

12. The method according to claim 1, wherein the network node is a base station, an access node, a radio access node or a next generation Node B, gNodeB.

13. A network node in a communications system for handling Physical Uplink Control Channel, PUCCH, resources in the frequency spectrum of the communications system, the network node being configured to:
categorize the PUCCH resources into a plurality of congestion level groups, wherein each congestion level group in the plurality of congestion level groups is associated with a number of User Equipment's, UE, in a cell sharing the PUCCH resources, wherein the PUCCH resources categorized in a first congestion level group are shared by a higher number of UE's than in a second congestion level group;
assign the categorized PUCCH resources to different parts of the frequency spectrum, wherein the first congestion level group is assigned to a first part of the frequency spectrum and the PUCCH resources categorized in the second congestion level group are assigned to a second part of the frequency spectrum, wherein the second part is closer to center of the frequency spectrum than the first part; and to
determine that the PUCCH resources categorized in the first congestion level group and assigned to the first part of the frequency spectrum should be used by the UE prior to using the PUCCH resources categorized in the second congestion level group and assigned to the second part of the frequency spectrum.

14. The network node according to claim 13 configured to:
determine, based on a UE priority, a number of PUCCH resources per set of PUCCH resources from each congestion level group of the plurality of congestion level groups to be used by the UE.

15. The network node according to claim 13, configured to categorize the PUCCH resources into a plurality of congestion level groups at any time, at cell setup or at a first time using any of the first congestion level group and the second congestion level group.

16. The network node according to claim 13, configured to assign the PUCCH resources categorized to the frequency spectrum are performed any time, at cell setup or at a first time using any of the first congestion level group and the second congestion level group.

17. The network node according to claim 14, configured to determine, based on the UE priority, the number of PUCCH resources per set of PUCCH resources from each congestion level group of the plurality of congestion level groups to be used by the UE at any time or at UE setup.

18. The network node according to claim 13, configured to assign the PUCCH resources categorized to different parts of the frequency spectrum by:
assigning a first Physical Resource Block, PRB, index or a first set of PRB index to the PUCCH resources categorized in the first congestion level group; and
assigning a second PRB index or a second set of PRB index to the PUCCH resources categorized in the second congestion level group.

19. The network node according to claim 18, wherein the first PRB index and the first set of PRB index are lower than the second PRB and the second set of PRB index.

20. The network node according to claim 14, wherein a first number of PUCCH resources is determined to be used by the UE when it has a first UE priority,
and wherein a second number of PUCCH resources is determined to be used by the UE when it has a second UE priority,
wherein the first number is higher than the second number, and the first UE priority is higher than the second UE priority.

21-26. (canceled)
